(19) United States
(12) Patent Application Publication
(10) Pub. No.: US 2005/0022468 A1
(43) Pub. Date: Feb. 3, 2005

(54) Web packaging pasteurization system

(75) Inventors: Robert E. Hanson, Middleton, WI (US); Craig R. Bonneville, Appleton, WI (US); Tou T. Vang, Lodi, WI (US); Vernon D. Karman, Poynette, WI (US); Gary Lee Hahn, Sun Prairie, WI (US); Nelly Feze, Madison, WI (US); John J. Jurkowski, Middleton, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Alkar-RapidPak, Inc., a corporation of the State of Wisconsin, Lodi, WI (US)

(21) Appl. No.: 10/930,631

(22) Filed: Aug. 31, 2004

Related U.S. Application Data
(63) Continuation of application No. 10/243,093, filed on Sep. 13, 2002.

(51) Int. Cl. B65G 11/06

(52) U.S. Cl. 53/222

(57) ABSTRACT

In a web packaging machine (10) and method packaging a food product (P) between upper and lower webs (14 and 25), wherein the lower web (14) is transported through a series of stations which form the lower web (14) into a component of a package at a forming station (18), and receive the food product (P) at a loading station (20), and close the package with the upper web (25) at a closing station (26), a pasteurization station (300) is provided between the loading station (20) and the closing station (26) and pasteurizing the food product (P).

### BACKGROUND AND SUMMARY

The invention relates to web packaging apparatus and methods transporting a web through a series of stations, for example forming a lower web: into a component of a package receiving a food product and closed by an upper web.

Web packaging machines and methods are known in the prior art, for example U.S. Pat. No. 5,170,611, incorporated herein by reference. The apparatus packages a food product between upper and lower webs. A web transport conveyor transports the lower -web through a series of stations which form the lower web into a component of a package at a forming station, and receive the food product at a loading station, and close the package with the upper web at a closing station. The present invention provides a pasteurization station pasteurizing the food product. In preferred form, the pasteurization station is between the loading station and the closing station and pasteurizes the food product in a simple effective manner readily and seamlessly incorporated into the packaging line.

### BRIEF DESCRIPTION OF THE DRAWINGS

FIG. 1 is an isometric view of web packaging apparatus in accordance with the invention.

FIG. 2 is a side view partially cut away of a portion of the apparatus of FIG. 1.

FIG. 3 is a view taken along line 3-3 of FIG. 2.

FIG. 4 is like FIG. 3 and illustrates sequential operation.

FIG. 5 is a view taken along line 5-5 of FIG. 4.

FIG. 6 is an enlarged view of a portion of FIG. 4.

FIG. 7 is like FIG. 6 and illustrates sequential operation.

FIG. 8 is an exploded isometric view partially folded away of a portion of the structure of FIG. 6.

FIG. 9 is an isometric view of a portion of FIG. 3.

FIG. 10 is like FIG. 9 and illustrates sequential operation.

### DETAILED DESCRIPTION

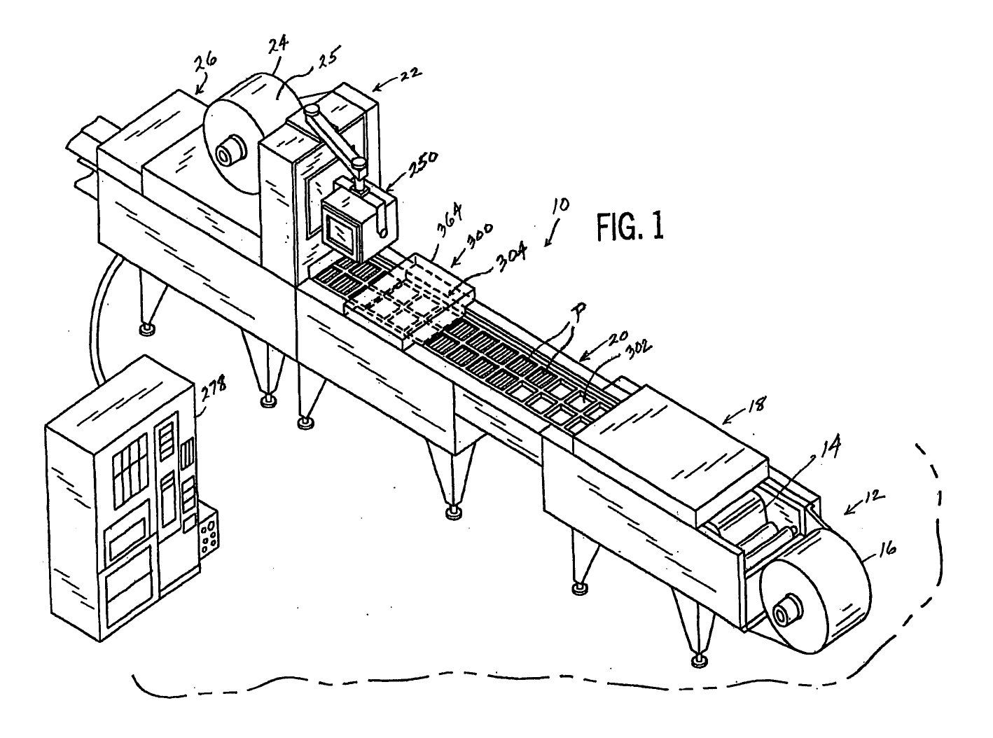

FIG. 1 illustrates a packaging machine 10 and is like FIG. 1 of incorporated U.S. Pat. No. 5,170,611 and uses like reference numerals therefrom where appropriate to facilitate understanding. As noted in the '611 patent, packaging machine 10 generally includes a lower web supply station 12 for supplying a lower web 14 of flexible packaging material from a supply roll 16, a forming station 18, a loading station 20, an upper web supply station 22 for supplying an upper web of flexible packaging material 25, and a downstream station 26 closing the package. As described in the '611 patent, the web transport conveyor provided by machine 10 transports lower web 14 through the noted series of stations which form the lower web into a component of a package at forming station 18, and receive the food product such as hot dogs P at loading station 20, and close the package with the upper web 25 at closing station 26. The webs are advanced by the indexing apparatus disclosed in the '611 patent, as controlled by the control modules 250 and 278, also as set forth in the '611 patent, to which further reference may be had. The conveyor advances from upstream to downstream, wherein closing station 26 is downstream of loading station 20, and loading station 20 is downstream of forming station 18.

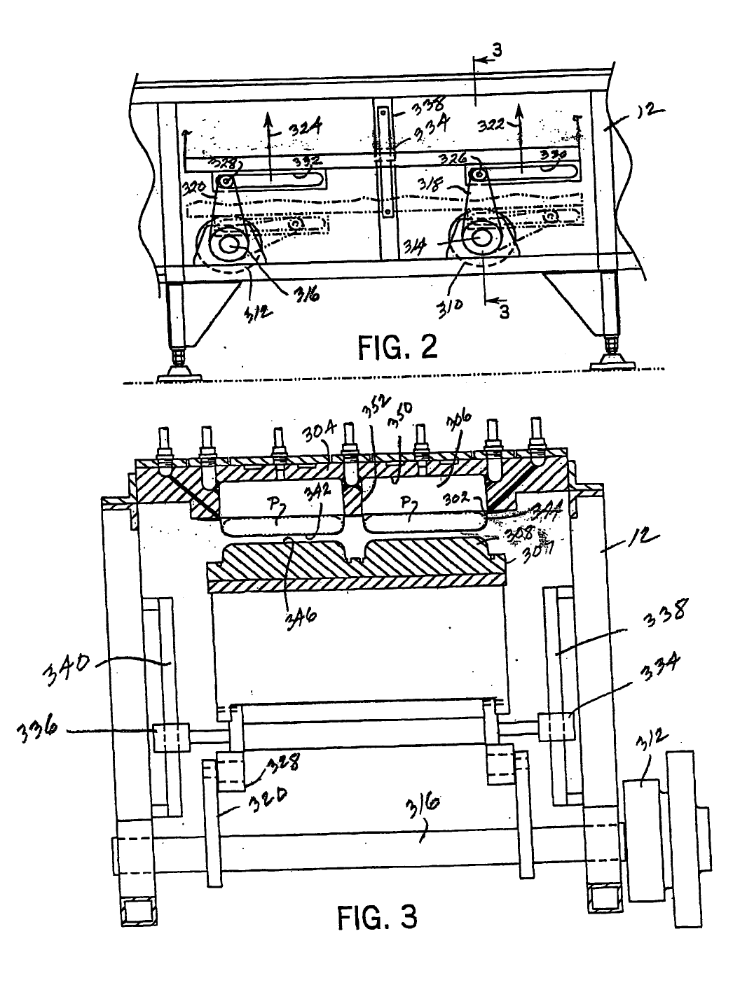

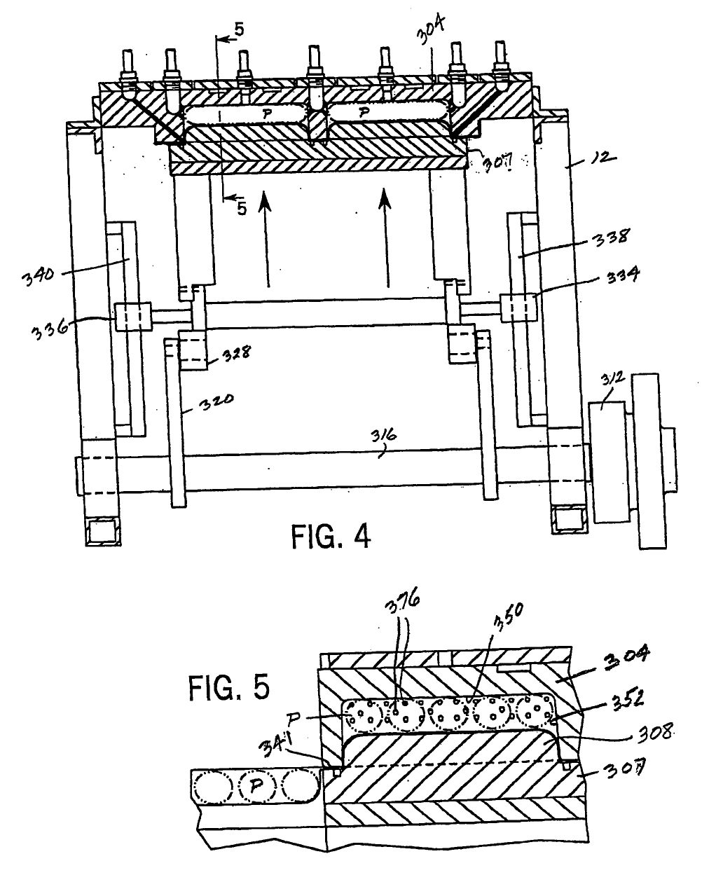

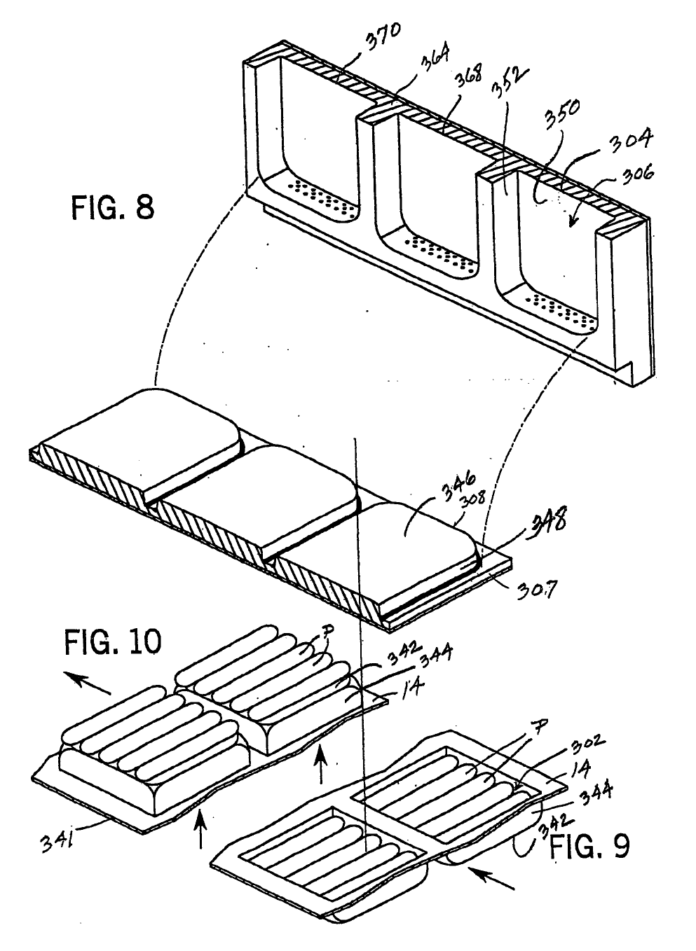

The present invention provides a pasteurization station 300 pasteurizing food product P. Pasteurization station 300 is between loading station 20 and closing station 26. Pasteurization station 300 is downstream of loading station 20, and is upstream of closing station 26. Forming station 18 forms a downwardly depending product cavity pocket 302, FIGS. 1, 9, 3, in lower web 14 into which food product P is loaded, in accordance with the noted '611 patent. Pasteurization station 300 includes an upper chamber 304, FIG. 8, having a downwardly facing pasteurization cavity 306 facing product cavity pocket 302, FIG. 3, and pasteurizing food product P, to be described. Upper chamber 304 is above web 14. The pasteurization station includes a lower chamber 307 preferably provided by a form-inverter 308, FIGS. 8, 3, below the web and movable upwardly, FIG. 4, to engage the underside of web 14 and push food product P upwardly into pasteurization cavity 306 in upper chamber 304. Form-inverter 308 is preferably moved upwardly and downwardly by servo motors comparably to those used in the '611 patent for raising and lowering the forming box at forming station 18 for forming the noted product cavity pocket, for example as shown in FIGS. 2, 4, 5 of the '611 patent. Servo motors 310, 312, FIG. 2, rotate respective shafts 314, 316 which in turn rotate respective lift arms 318 and 320 from the lower position shown in dashed line in FIG. 2 to the upper position shown in solid line in FIG. 2 to in turn move form-inverter 308 upwardly as shown at arrows 322, 324, comparably to the upward movement provided by lift arms 128 and 216 in FIGS. 2 and 5 of the '611 patent. Roller members 326, 328 at the ends of respective arms 318, 320 roll along respective cam slots 330, 332 along the underside of form-inverter 308 comparably to roller member 132 in FIG. 5 of the '611 patent rolling along cam slot 134. The form-inverter is guided for up-down reciprocal movement by plastic bearing blocks 334, 336 sliding along vertical guides 338, 340 of frame 12, comparably to plastic bearing blocks 140 and guides 144 of the '611 patent. Upper and lower chambers 304 and 307 mate, FIGS. 4-7, to form a pressure-containing vessel enclosing cavity 306 sealed along its periphery in gasket-like manner by web 14 engaged between members 304 and 307 as shown at portion 341.

Product cavity pocket 302 of web 14 has a first condition, FIGS. 9, 3, at pasteurization station 300, with the downwardly depending product cavity pocket 302 having a lower central wall 342 and a plurality of sidewalls 344 extending upwardly therefrom. Product cavity pocket 302 has a second condition, FIGS. 10, 4, at the pasteurization station, with form-inverter 308 pushing central wall 342 upwardly to an upwardly pushed position, FIG. 10, with sidewalls 344 extending downwardly therefrom. Form-inverter 308 has an upper central wall 346, FIG. 9, and a plurality of sidewalls 348 extending downwardly therefrom. Product cavity pocket 302 in the noted second condition, FIG. 10, is draped over and supported by form-inverter 308, with central wall 342 on central wall 346, and sidewalls 344 extending along sidewalls 348. Product cavity pocket 302 has an initial condition as shown in FIG. 9 receiving food product P therein. The package is inverted as shown in FIG. 10 to better expose food product P for pasteurization. Upper chamber 304 has an upper central wall 350, FIG. 8, and a plurality of sidewalls 352 extending downwardly therefrom. In the noted first condition, FIGS. 9, 3, of product cavity pocket 302, food product P is supported on central wall 342 of the product cavity pocket and retained by sidewalls 344 of the product cavity pocket. In the noted second condition, FIGS. 10, 4, 5, of product cavity pocket 302, food product P is supported on central wall 342 of the product cavity pocket and laterally retained by sidewalls 352 of upper chamber 304.

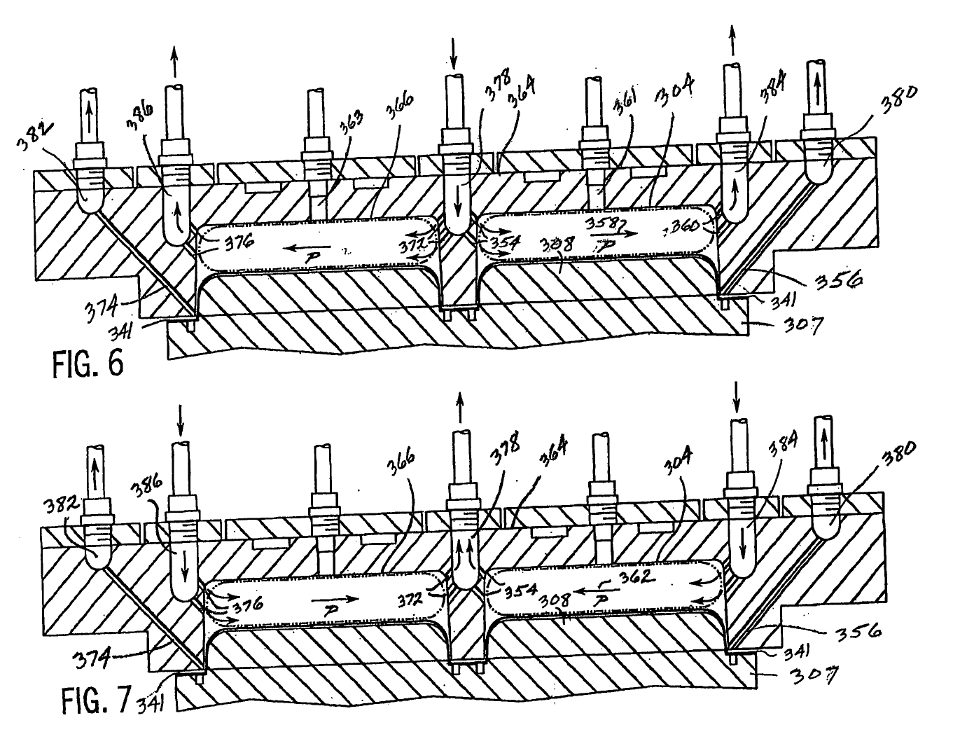

Pasteurization chamber 304, FIG. 6, has a set of one or more ports 354, and a set of one or more ports 356. Ports 354 introduce a pasteurizing medium, preferably steam, and ports 356 evacuate and vent the pasteurizing medium, such that the pasteurizing medium flows across food product P as shown at arrow 358 between ports 354 and 356. Ports 356 are at a gravitationally low section of pasteurization cavity 306 and also preferably discharge liquid condensate from the steam. Steam may be additionally or alternatively evacuated and vented at another set of one or more ports 360. In preferred form, pasteurization station 300 has a pasteurization cycle alternating between first and second modes providing alternating flow direction of the pasteurizing medium, preferably steam, across food product P. In the first mode, steam is introduced through ports 354, and in the second mode the steam is introduced through ports 360. In the first mode, the steam may be vented through ports 356 and/or ports 360. In the second mode, the steam may be vented through ports 356 and/or ports 354, the latter venting being shown at arrow 362 in FIG. 7. In another embodiment, steam is introduced simultaneously from both sets of ports 354 and 360. Pressure and/or temperature sensing is provided at pressure and/or temperature transducer ports 361, 363, for monitoring purposes and better process control if desired.

In one preferred embodiment, the pasteurization station is provided by a module 364, FIGS. 1, 8, having at least a pair of laterally spaced side by side chambers 304 and 366, FIG. 6, and further preferably a plurality of such pairs, for example one each of which is shown in FIG. 8 at 304, 368, 370 in series along the direction of web transport. The other chamber of each pair has a like set of ports; for example chamber 366, FIG. 6, has a set of one or more ports 372 and another set of one or more ports 374 and may have a further set of one or more ports 376. The pasteurization station may include one or more modules 364. Each module 364 has flow passages 378, 380, 382, and may have further flow passages 384 and 386. During the first mode of the pasteurization cycle, FIG. 6, steam is introduced through flow passage 378 and ports 354 and 372 into respective chambers 304 and 366 and is vented through respective ports 356 and 374 through respective flow passages 380 and 382, and may additionally or alternatively be vented through respective ports 360 and 376 through respective flow passages 384 and 386. Liquid condensate from the steam is discharged through respective ports 356 and 374 through respective passages 380 and 382. During the second mode of the pasteurization cycle, FIG. 7, steam is introduced through flow passages 384 and 386 and respective ports 360 and 376 into respective chamber 304 and 366, and is vented at respective ports 356 and 374 through respective passages 380 and 382 and may additionally or alternatively be vented at ports 354 and 372 through flow passage 378. Upon completion of pasteurization, the package is re-inverted to its noted initial condition, FIG. 9, by lowering form-inverter 308. The package is then advanced and closed with the upper web 25 at closing station 26 as in the noted '611 patent.

It is recognized that various equivalents, alternatives and modifications are possible within the scope of the appended claims. The term pasteurization is used herein in accordance with its normal dictionary definition, including partial sterilization of a substance at a temperature and for a period of exposure that destroys objectionable organisms without major chemical alteration of the substance, and including destruction of pathogenic and/or spoilage organisms for extending shelf life. The invention may be used with various web packaging apparatus known in the prior art, including continuous motion type web packaging machines and indexing type web packaging machines. It is preferred that plural packages of food product be simultaneously processed at the pasteurization station, FIGS. 8-10, though the invention is not limited to any particular number, i.e. the invention includes the pasteurization of one or more product packages. Furthermore, additional pasteurization stations may- be added, and the invention includes one or more pasteurization stations, each having one or more pasteurization chambers. Food product inversion is preferred, e.g. via form-inverter 308, but is not necessary, and may be deleted if desired. The pasteurizing medium is preferably steam, or alternatively hot air or superheated steam, though other types of pasteurizing media may be used.

1-28. (canceled)

29. Packaging apparatus comprising a web transport conveyor transporting a web through a series of stations which form the web into a component of a package receiving a food product, including a pasteurization station pasteurizing said food product, said pasteurization station comprising a chamber having a first set of one or more ports and a second set of one or more ports, said first set of one or more ports introducing a pasteurizing medium, said second set of one or more ports venting said pasteurizing medium such that said pasteurizing medium flows across said food product between said first and second sets of ports.

30. Packaging apparatus comprising a web transport conveyor transporting a web through a series of stations which form the web into a component of a package receiving a food product, including a pasteurization station pasteurizing said food product, said pasteurization station having a first set of one or more ports introducing pasteurizing medium for flow across said food product from a first end of said food product, said pasteurization station having a second set of one or more ports spaced from said first set of one or more ports and introducing pasteurizing medium for flow across said food product from a second distally opposite end of said food product.

31. The packaging apparatus according to claim 30 wherein said pasteurizing medium is introduced simultaneously from both of said first and second sets of ports to simultaneously flow across said food product from each of said first and second distally opposite ends of said food product.

32. Packaging apparatus comprising a web transport conveyor transporting a web through a series of stations which form the web into a component of a package receiving a food product, including a pasteurization station pasteurizing said food product, said pasteurization station having a pasteurization cycle alternating between first and second modes providing alternating flow direction of said pasteurizing medium across said food product, wherein in said first mode said pasteurizing medium is introduced through a first set of one or more ports, and in said second mode said pasteurizing medium is introduced through a second set of one or more ports, to alternate said flow direction of said pasteurizing medium across said food product.

33. Packaging apparatus comprising a web transport conveyor transporting a web through a series of stations which form the web into a component of a package receiving a food product, including a pasteurization station pasteurizing said food product, said pasteurization station comprising a module having a pair of side by side chambers, comprising a first chamber having a first set of one or more ports and a second set of one or more ports, and a second chamber having a third set of one or more ports and a fourth set of one or more ports, said module comprising first, second and third flow passages, said first flow passage communicating with said first and third sets of one or more ports, said second flow passage communicating with said second set of one or more ports, said third flow passage communicating with said fourth set of one or more ports.

34. The packaging apparatus according to claim 33 wherein said pasteurization station has a pasteurization cycle alternating between first and second modes providing alternating flow direction of a pasteurizing medium across said food product in each of said first and second chambers, wherein in said first mode said pasteurizing medium is introduced through said first flow passage to said first and third sets of one or more ports, and in said second mode said pasteurizing medium is introduced through said second and third flow passages to said second and fourth sets of one or more ports, respectively.

35. Packaging apparatus comprising a web transport conveyor transporting a web through a series of stations which form the web into a component of a package receiving a food product, including a pasteurization station pasteurizing said food product, said pasteurization station pasteurizing said food product with a pasteurizing medium comprising steam, said pasteurization station comprising a chamber having a first set of one or more ports introducing said steam and a second set of one or more ports at a gravitationally low section of said chamber and discharging liquid condensate from said steam.

36. The packaging apparatus according to claim 35 wherein said second set of one or more ports also vent said steam.

37. The packaging apparatus according to claim 35 comprising a third set of one or more ports venting said steam.

38. Packaging apparatus packaging a food product between upper and lower webs, comprising a web transport conveyor transporting said lower web from upstream to downstream through a series of stations receiving the food product in a lower web package at a loading station, and closing the package with the upper web at a closing station, and including a pasteurization station downstream of said loading station and upstream of said closing station and pasteurizing the food product with a pasteurizing medium injected into a pasteurization chamber through an entry port and removed from said pasteurization chamber through an exit port, said exit port being separate from and spaced from said entry port, such that said pasteurizing medium enters said chamber at a first location at said entry port and pasteurizes said food product and exits said chamber at a second different location at said exit port.

39. Packaging apparatus packaging a food product between upper and lower webs, comprising a web transport conveyor transporting said lower web from upstream to downstream through a series of stations receiving the food product in a lower web package at a loading station, and closing the package with the upper web at a closing station, and including a pasteurization station downstream of said loading station and upstream of said closing station and pasteurizing the food product with a pasteurizing medium injected into a pasteurization chamber through an entry port and removed from said pasteurization chamber through an exit port, said pasteurization station comprising an upper chamber having a downwardly facing pasteurization cavity facing the food product without said upper web therebetween.

40. Packaging apparatus packaging a food product between upper and lower webs, comprising a web transport conveyor transporting said lower web from upstream to downstream through a series of stations receiving the food product in a lower web package at a loading station, and closing the package with the upper web at a closing station, and including a pasteurization station downstream of said loading station and upstream of said closing station and pasteurizing the food product with a pasteurizing medium injected into a pasteurization chamber through an entry port and removed from said pasteurization chamber through an exit port, said pasteurization station including a lower chamber below said lower web and an upper chamber above said lower web and having a downwardly facing pasteurization cavity facing the food product, one of said upper and lower chambers being movable toward the other of said upper and lower chambers to form a pressure-containing vessel enclosing said pasteurization cavity and sealed along its periphery by a portion of said lower web engaged between said chambers without said upper web therebetween, said pasteurizing medium passing into and out of said pasteurization cavity without passing through the interface between said upper and lower webs.

41. A method for packaging a food product comprising providing a web transport conveyor and transporting a web through a series of stations and forming the web into a component of a package receiving a food product, providing a pasteurization station with a pasteurization chamber having a first set of one or more ports and a second set of one or more ports, pasteurizing said food product with a pasteurization cycle having first and second modes, comprising in said mode introducing pasteurizing medium from said first set of one or more ports, and in said second mode introducing pasteurizing medium from said second set of one or more ports, and comprising alternating between first and second modes during said pasteurization cycle.
